(19) United States
(12) Patent Application Publication
(10) Pub. No.: US 2026/0241756 A1
(43) Pub. Date: Aug. 20, 2026

(54) VALVE ASSEMBLY FOR TIRE PRESSURE SENSING

(71) Applicant: SYSGRATION LTD., TAIPEI CITY (TW)

(72) Inventors: Meng Jie Tsai, TAIPEI CITY (TW); Szu Wei Chang, TAIPEI CITY (TW); Yuan Long Wang, TAIPEI CITY (TW); SHENG-HAO LEE, TAIPEI CITY (TW)

(21) Appl. No.: 19/534,785

(22) Filed: Feb. 10, 2026

(30) Foreign Application Priority Data
Feb. 20, 2025 (TW) 114106175

(51) Int. Cl. B60C 23/04

(52) U.S. Cl. CPC B60C 23/0496

(57) ABSTRACT

A valve assembly for tire pressure sensing includes a seat body, a valve connector, and an adapter. The seat body has a circuit board and a pressure chamber in communication therewith, with an assembly portion having a first flow passage communicating with the pressure chamber. The valve connector connects a valve to the assembly portion and has a second flow passage, an internal threaded section on its inner wall, and an air guiding hole on its outer wall communicating with both flow passages. The adapter, locked in the valve connector via corresponding external threads, forms an air guiding flow passage with the internal threaded section. When assembled on a valve stem, air from the valve flows through the second flow passage, the air guiding flow passage, the air guiding hole, and the first flow passage into the pressure chamber, enabling the circuit board to sense tire pressure.

### BACKGROUND OF THE INVENTION

### Fields of the invention

The present invention relates to the technical field of tire pressure sensing, and more particularly, to a valve assembly for tire pressure sensing.

### Descriptions of Related Art

Currently, there are mainly two types of assembly methods for bicycle tire pressure detection. One is to directly lock a TPMS (Tire Pressure Monitoring System) on the top end of a valve, but the disadvantage of this assembly method is that the excessively high assembly position of the TPMS affects aesthetics. The other is to communicate with a sensor through holes on a specially-made valve wall surface, however, the disadvantages of this assembly method are excessive replacement parts, troublesome assembly, and poor air tightness. Therefore, how to improve the disadvantages of the above-mentioned bicycle tire pressure detection assembly methods is one of the primary objectives of the present invention.

The present invention intends to provide a valve assembly for tire pressure sensing to eliminate shortcomings mentioned above.

### SUMMARY OF THE INVENTION

The primary objective of the present invention is to provide a valve assembly for tire pressure sensing that is not directly mounted on the top end of a valve, does not increase the installation height, and does not require additional manufacturing of the installed valve.

The present invention provides a valve assembly for tire pressure sensing installed on a valve stem of a tire, and comprises a seat body having an assembly portion protruding from one side of the seat body. The seat body has a circuit board disposed therein and a pressure chamber in communication with the circuit board. The assembly portion has a first flow passage in communication with the pressure chamber. A valve connector has two ends respectively assembled to a valve and the assembly portion of the seat body, and has a second flow passage therein. An inner wall of the valve connector has an internal threaded section and an outer wall has an air guiding hole. The air guiding hole is in communication with the second flow passage and the first flow passage respectively. An adapter is locked in the valve connector and has an external threaded section on an outer wall thereof corresponding to the internal threaded section of the valve connector. An air guiding flow passage in communication with the air guiding hole is disposed between the external threaded section and the internal threaded section. The seat body is locked on the valve stem through the adapter, such that a portion of air generated from the valve flows into the second flow passage, flows through the air guiding flow passage toward the air guiding hole, flows into the first flow passage through the air guiding hole, and finally flows into the pressure chamber through the first flow passage, enabling the circuit board in communication with the pressure chamber to sense the air state of the pressure chamber.

Preferably, a guide inclined hole is in communication between the pressure chamber of the seat body and the first flow passage.

Preferably, the seat body is composed of a first base and a second base. The first base and the second base respectively have a corresponding first positioning portion and a second positioning portion therein. The circuit board is positioned between the first positioning portion and the second positioning portion.

Preferably, the first base has a locking hole defined through the interior of the seat body. The second positioning portion and the circuit board respectively have a first through hole and a second through hole corresponding to the locking hole.

Preferably, the valve stem and the adapter have a first locking section and a second locking section respectively disposed at corresponding locking positions.

Preferably, the adapter and the valve stem respectively have an adapter passage and a valve passage in communication with each other therein. The adapter passage is in communication with the second flow passage, such that air from the valve flows through the second flow passage to the adapter passage and flows into the tire through the valve passage.

Preferably, the first base has a locking member at a position corresponding to the locking hole. When the valve stem passes through the locking hole, the second through hole and the first through hole to enter the interior of the seat body and is locked to the adapter, the valve stem is locked to the locking hole by the locking member, such that the valve stem and the seat body are mutually locked together.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded perspective view of the present invention;

FIG. 2 is an assembled perspective view of the present invention;

FIG. 3 is a cross-sectional view, taken along line III-III of FIG. 2 of the present invention;

FIG. 4 is a schematic cross-sectional view showing air flow direction according to FIG. 3 of the present invention, and

FIG. 5 is a schematic view showing the present invention installed on a wheel rim of a tire.

### DETAILED DESCRIPTION OF THE PREFERRED EMBODIMENT

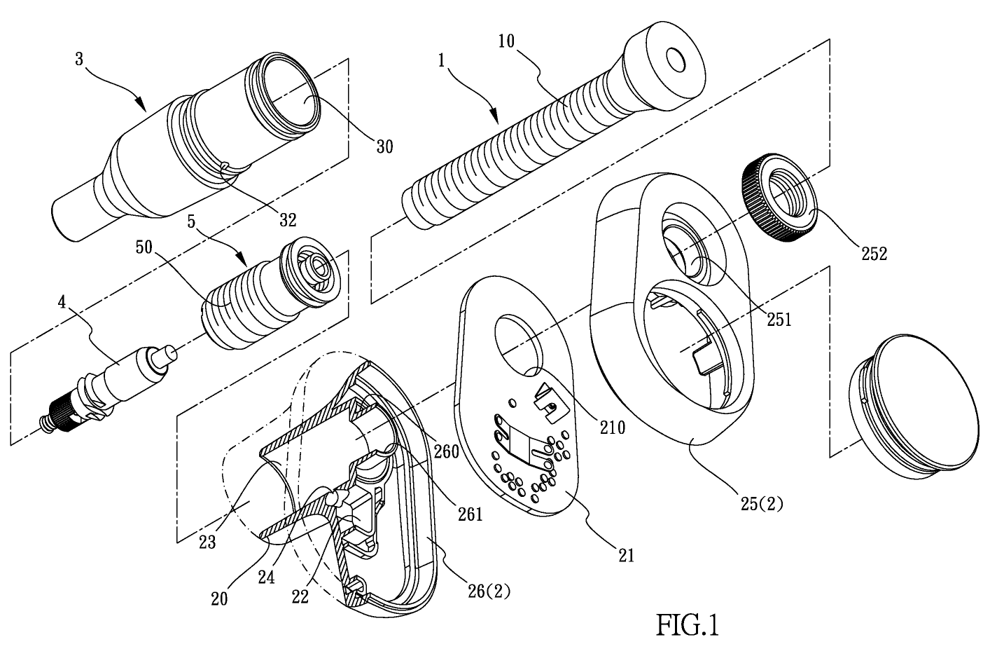

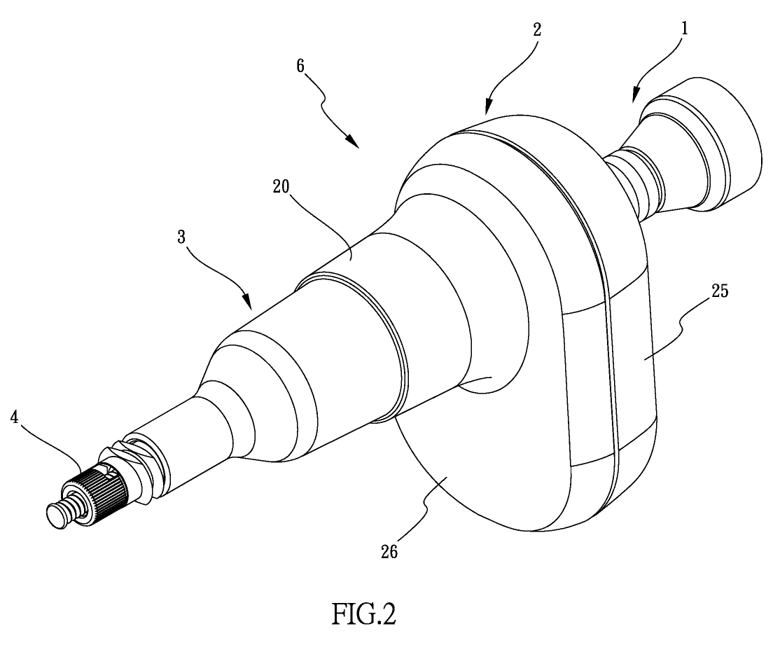

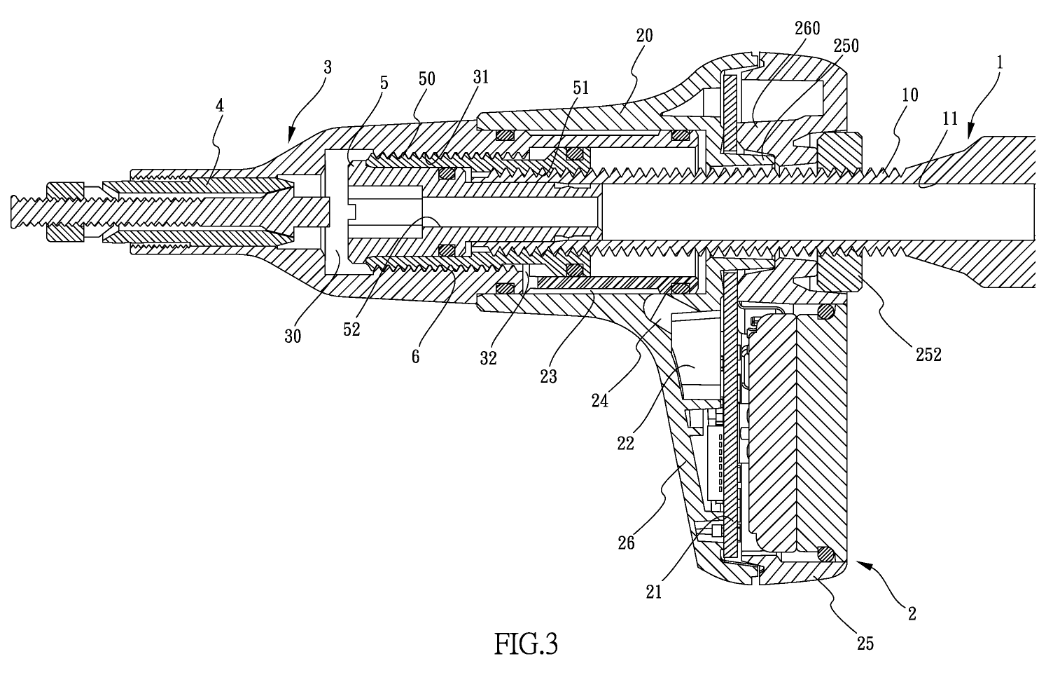

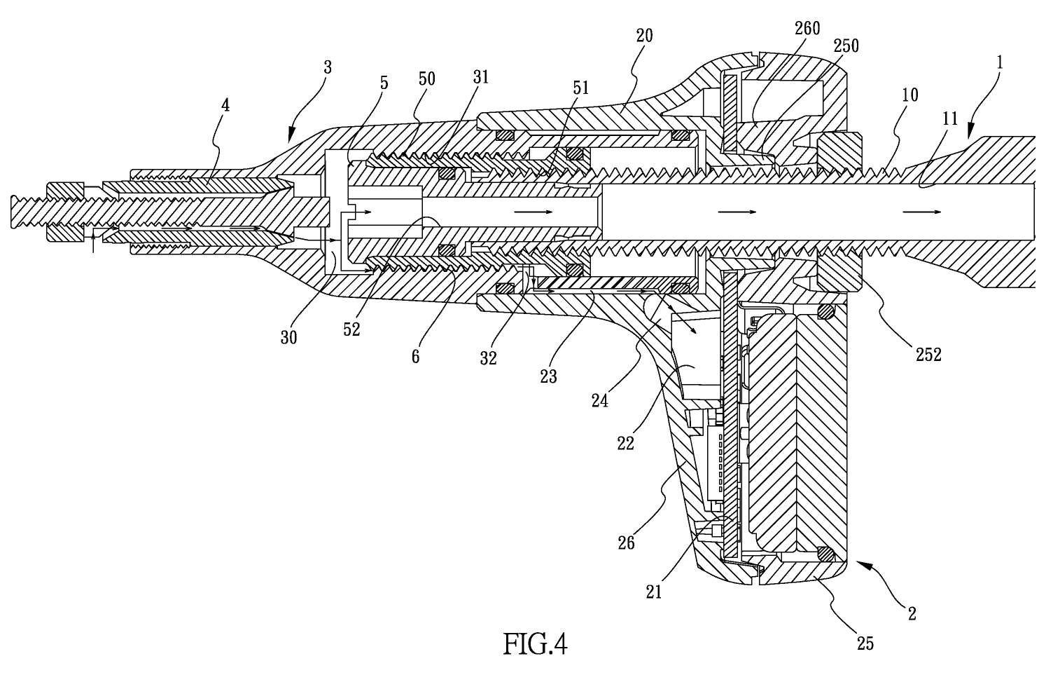

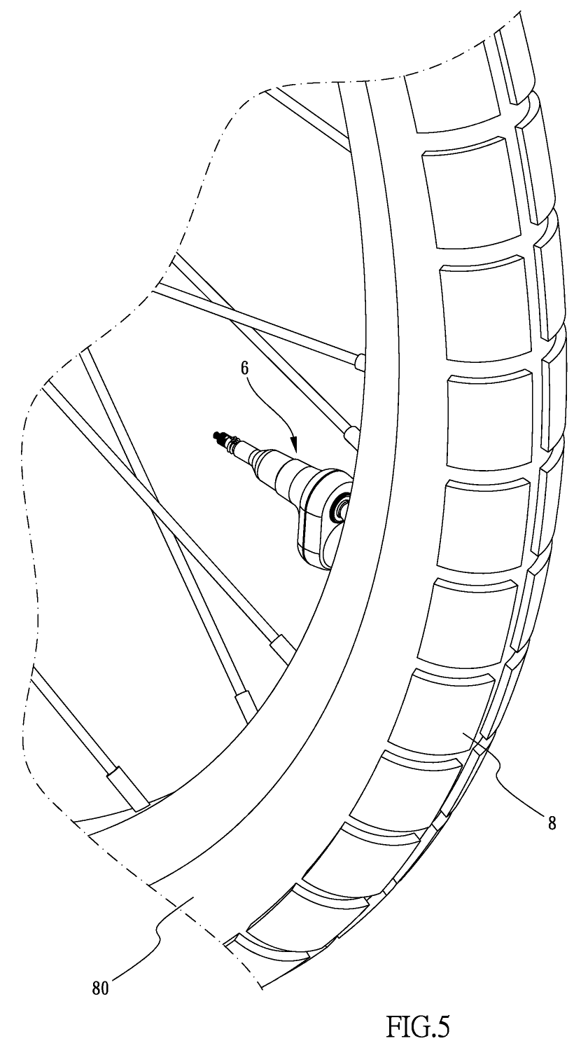

Referring to FIGS. 1 to 5, the present invention relates to a valve assembly for tire pressure sensing, and comprises a valve stem 1 which is installed on a wheel rim 80 of a tire 8 of a bicycle. The valve stem 1 has a first locking section 10 on an outer surface thereof and has a valve passage 11 therein.

A seat body 2 has an assembly portion 20 protruding from one side of the seat body 2. The seat body 2 has a circuit board 21 disposed therein and a pressure chamber 22 in communication with the circuit board 21. The assembly portion 20 further has a first flow passage 23 in communication with the pressure chamber 22 therein, and a guide inclined hole 24 is in communication between the pressure chamber 22 and the first flow passage 23. Furthermore, the seat body 2 is composed of a first base 25 and a second base 26. The first base 25 and the second base 26 respectively have a corresponding first positioning portion 250 and a second positioning portion 260 therein. The circuit board 21 is positioned therein by the first positioning portion 250 and the second positioning portion 260. Additionally, the first base 25 has a locking hole 251 through the interior of the seat body 2. The second positioning portion 260 and the circuit board 21 respectively have a first through hole 261 and a second through hole 210 corresponding to the locking hole 251. The first base 25 further has a locking member 252 disposed at a position corresponding to the locking hole 251. When the valve stem 1 is locked into the interior of the seat body 2, the valve stem 1 is locked to the position of the locking hole 251 by the locking member 252, such that the valve stem 1 and the seat body 2 are mutually locked together.

A valve connector 3 has two ends respectively assembled to a valve 4 and the assembly portion 20 of the seat body 2, and has a second flow passage 30 therein. An inner wall of the valve connector 3 has an internal threaded section 31 and an outer wall has an air guiding hole 32. The air guiding hole 32 is in communication with the second flow passage 30 and the first flow passage 23 respectively.

An adapter 5 is locked in the valve connector 3 and has an external threaded section 50 on an outer wall thereof corresponding to the internal threaded section 31 of the valve connector 3. The adapter 5 has a second locking section 51 for locking with the first locking section 10 of the valve stem 1, and the adapter 5 has an adapter passage 52 in communication with the valve passage 11 of the valve stem 1 therein.

In assembly, when the adapter 5 is locked to the internal threaded section 31 of the valve connector 3 through the external threaded section 50, and the adapter 5 is locked in the valve connector 3, an air guiding flow passage 6 in communication with the air guiding hole 32 is formed between the external threaded section 50 of the adapter 5 and the internal threaded section 31 of the valve connector 3. The valve stem 1 sequentially passes through the locking hole 251, the second through hole 210, and the first through hole 261 to enter the interior of the seat body 2, and the valve stem 1 is locked to the second locking section 51 of the adapter 5 by the first locking section 10. Accordingly, the seat body 2 is locked on the wheel rim 80 of the tire 8, and air from the valve 4 flows through the second flow passage 30 of the valve connector 3 to the adapter passage 52 of the adapter 5, and flows into the tire 82 of the bicycle through the valve passage 11 of the valve stem 1, achieving the effect of inflating the tire 8.

In implementation, the valve assembly 7 of the present invention not only enables the seat body 2 and the valve stem 1 to be mutually locked through the adapter 5, but also allows the height of the seat body 2 of the valve assembly 7 on the valve 4 to be adjusted through the relative locking travel of the seat body 2, the adapter 5, and the valve stem 1, enabling the valve assembly 7 to be installed on wheel rims 80 of different tires 8. Furthermore, a portion of air from the valve 4 can flow through the air guiding flow passage 6 from the second flow passage 30 toward the air guiding hole 32, flow into the first flow passage 23 through the air guiding hole 32, and finally flow through the first flow passage 23 to the pressure chamber 22, enabling the circuit board 21 in communication with the pressure chamber 22 to sense the air state of the pressure chamber 22. In this embodiment, the air in the first flow passage 23 is more smoothly guided to the pressure chamber 22 through the guide inclined hole 24, avoiding air blockage.

While we have shown and described the embodiment in accordance with the present invention, it should be clear to those skilled in the art that further embodiments may be made without departing from the scope of the present invention.

What is claimed is:

1. A valve assembly for tire pressure sensing installed on a valve stem of a tire, comprising:
a seat body having an assembly portion protruding from one side of the seat body, the seat body having a circuit board disposed therein and a pressure chamber in communication with the circuit board, the assembly portion having a first flow passage in communication with the pressure chamber;
a valve connector having two ends respectively assembled to a valve and the assembly portion of the seat body and having a second flow passage therein, an inner wall of the valve connector having an internal threaded section and an outer wall having an air guiding hole, the air guiding hole being in communication with the second flow passage and the first flow passage respectively, and
an adapter locked in the valve connector and having an external threaded section on an outer wall thereof corresponding to the internal threaded section of the valve connector, an air guiding flow passage in communication with the air guiding hole being disposed between the external threaded section and the internal threaded section, when the seat body is locked on the valve stem through the adapter, a portion of air generated from the valve flows into the second flow passage, flows through the air guiding flow passage toward the air guiding hole, flows into the first flow passage through the air guiding hole, and finally flows into the pressure chamber through the first flow passage, enabling the circuit board in communication with the pressure chamber to sense the air state of the pressure chamber.

2. The valve assembly for tire pressure sensing as claimed in claim 1, wherein a guide inclined hole is in communication between the pressure chamber of the seat body and the first flow passage.

3. The valve assembly for tire pressure sensing as claimed in claim 1, wherein the seat body is composed of a first base and a second base, the first base and the second base respectively have a corresponding first positioning portion and a second positioning portion therein, and the circuit board is positioned between the first positioning portion and the second positioning portion.

4. The valve assembly for tire pressure sensing as claimed in claim 3, wherein the first base has a locking hole defined through the seat body, and the second positioning portion and the circuit board respectively have a first through hole and a second through hole corresponding to the locking hole.

5. The valve assembly for tire pressure sensing as claimed in claim 4, wherein the first base has a locking member at a position corresponding to the locking hole, and when the valve stem passes through the locking hole, the second through hole and the first through hole to enter the interior of the seat body and is locked to the adapter, the valve stem is locked to the locking hole by the locking member, such that the valve stem and the seat body are mutually locked together.

6. The valve assembly for tire pressure sensing as claimed in claim 1, wherein the valve stem and the adapter have a first locking section and a second locking section respectively disposed at corresponding locking positions.

7. The valve assembly for tire pressure sensing as claimed in claim 1, wherein the adapter and the valve stem respectively have an adapter passage and a valve passage in communication with each other therein, and the adapter passage is in communication with the second flow passage, such that air from the valve flows through the second flow passage to the adapter passage and flows into the tire through the valve passage.
